(19) United States
(12) Patent Application Publication
(10) Pub. No.: US 2016/0281877 A1
(43) Pub. Date: Sep. 29, 2016

(54) BRACKET USED FOR BALL VALVE AND TRUNNION BALL VALVE

(71) Applicant: ZENGHUA HE, Shanghai (CN)

(72) Inventor: ZENGHUA HE, Shanghai (CN)

(21) Appl. No.: 14/871,283

(22) Filed: Sep. 30, 2015

(30) Foreign Application Priority Data
Mar. 27, 2015 (CN) 201510140559.9

(51) Int. Cl. F16K 27/06; F16K 5/06

(52) U.S. Cl. CPC F16K 27/067; F16K 5/0647; F16K 5/0663

(57) ABSTRACT

The present invention discloses a bracket used for a ball valve, which includes: at least two supporting legs, and a stopper plate located above the supporting legs; a lower surface of each of the supporting legs contacts an upper surface of a valve body of the trunnion ball valve; and the stopper plate includes a through hole therein passing through a valve stem of the trunnion ball valve. Meanwhile, the present invention discloses a trunnion ball valve, which includes: a valve body, a valve ball, two valve seats, and a valve stem. The valve body includes a valve body cavity and a packing cavity therein. The valve ball and the valve seats are all located within the valve body cavity. The valve stem connecting with the valve ball is located within the packing cavity. Graphite packings are filled between the packing cavity and the valve stem, and the graphite packings are pressed tightly by adjusting the height of a packing gland.

### CROSS-REFERENCE TO RELATED APPLICATIONS

The present application claims priority under 35 U.S.C. §119 to Chinese patent application CN201510140559.9, filed Mar. 37, 2015, the disclosure of which is incorporated herein by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND

1. Technical Field

The present invention relates to a fluid control type of valves, and more particularly to a bracket used for a ball valve and a trunnion ball valve.

2. Related Art

A ball valve, having an open-and-close element (valve ball) which is driven by a valve stem and rotates around an axial line of the valve stem for a quarter turn (90 degrees), is mainly used for regulating and controlling fluid flows. Ever since the ball valve is developed, it has been widely applied in petroleum processing, long-distance pipelines, chemical engineering, manufacturing of papers, pharmaceuticals, civil engineering, electric power suppliers, municipal administration, steel industries, and more, and is considered as an indispensable part in the mechanical engineering.

The primary features of the ball valve include a compact and simple structure, being well sealed, and easily repairable. Moreover, in the ball valve, a seal surface and a spherical surface are usually in a closed position under a pressure from mediums, which is resistant to corrosion by the mediums, and easy for operation and maintenance. Thus, the ball valve is applicable to common working mediums such as water, solvent, acid, natural gas, etc., and also applicable to mediums bringing in severe working environment such as oxygen, hydrogen peroxide, methane, ethylene, etc. Thus, the ball valve is widely applied in various industries. The valve body of the ball valve may be one integral piece or not.

Prior art ball valve may be sorted into a floating ball valve and a trunnion ball valve. The floating ball valve refers to the ball valve of which a ball is floating. Under the pressure from the mediums, the ball may experience a certain displacement, and thus is tightly pressed against the seal surface at an outlet end, which guarantees sealing effects at the outlet end. The higher the pressure is, the better the sealing effects would be. However, the torque for actuating and closing the valve may be increased as the pressure increases. The floating ball valve has a simple structure and offers better sealing effects. But the load of the working medium bore by the ball is completely transferred to the valve seat at the outlet side, so that it needs to consider whether the valve seats can bear working pressure of the working medium. Once being squeezed by a higher pressure, the valve seat made of a soft material may be shifted; as a result, the sealing effects may be impaired. Structure aforementioned is more applicable to a medium-and-low-pressure environment with a smaller bore size.

Compared with the floating ball valve, the trunnion ball valve has a fixing ball, and two floating valve seats. During operations, the acting force generated by the mediums is transferred from the ball to the valve stem and a fixing shaft, which prevents the ball from moving towards the valve seat at the outlet. Thus, the valve seats do not need to bear an excessively high pressure, and the trunnion ball valve may have a smaller torque, a smaller deformation of the valve seats, a stable sealing performance, and a longer service life. Thus, the trunnion ball valve may be applicable to a high pressure environment with a larger bore size.

Generally, in order to secure a fixed position of the ball, the trunnion ball valve secures the ball at an upper end point and a lower end point. Thus, the structure becomes complicated, and the manufacturing process is more complicated than that of a floating ball valve, so that the manufacturing cost becomes higher accordingly. Moreover, in the trunnion ball valve, the valve stem and the valve body are sealed to each other by using a rubber material in between, which is easily worn and aging under high temperatures and high pressures. Every time replacing a sealing ring, the valve must be disassembled, and the valve stem must be detached, which means the repair and maintenance operations are rather inconvenience, and the whole pipeline operations must be shut off, that is, operations have to be temporally stopped.

### SUMMARIZED DESCRIPTION OF THE INVENTION

To overcome the defects in the prior art, the present invention provides a trunnion ball valve which has a lower manufacturing cost and is more user-friendly.

To fulfill the objectives, the present invention discloses a bracket provided to a trunnion ball valve, which includes: at least two supporting legs, and a stopper plate located above the supporting legs, wherein a lower surface of each of the supporting legs contacts an upper surface of a valve body of the trunnion ball valve, and an accommodating space is formed between the supporting legs and the stopper plate.

Preferably, the bracket includes four supporting legs having a connecting slot thereon respectively, and the stopper plate includes at least one recessed boss used to accommodate a first bolt for fixing the bracket to the valve body.

Yet another embodiment of the present invention is the trunnion ball valve, which includes: a valve body, a valve ball, two valve seats, and a valve stem. The valve body includes a body cavity and a packing box. The ball and the valve seats are all assembled inside the valve body cavity. The valve stem connecting with the valve ball is assembled within the packing box. Graphite packings are filled between the packing box and the valve stem, and are pressed tightly by the presence of a packing gland.

Preferably, the height of the packing gland is adjustable.

Preferably, the trunnion ball valve further includes the bracket located above the valve body, in which the packing gland is located within a space formed by the valve body and the bracket.

Preferably, the bracket includes at least two supporting legs and the stopper plate located above the supporting legs, the lower surface of each supporting leg contacts the upper surface of the valve body, and the stopper plate includes a through hole wherein the valve stem may pass through.

Preferably, the valve body is made of either bar materials or forging pieces.

Preferably, the valve seats are connected with the valve body by elastic elements, and the valve seats are made of metal or ceramic.

Preferably, the valve stem is located within an upper fixing slot of the ball, a slot bottom of the upper fixing slot is formed into a circular arc shape, and the valve stem is shaped to match to that of the upper fixing slot.

Preferably, the packing gland is fixed with the valve body by a second the bolt, and the height of the packing gland is adjusted by adjusting the height of the bolt.

Preferably, the bracket is provided with a pre-reserved space on its surface, which is for installing an auto-control device.

Compared with the prior art, firstly, the structure provided based on the technical solutions of the present invention can reduce the frequency of parts replacement and maintenance by adjusting the height of the packing use during routine maintenance without disassembling any part, which is more convenient than using O-shaped seal ring that is non-adjustable. Secondly, the structure of the trunnion ball valve provided by the present invention is simpler than that in the prior art. Thirdly, by using the bracket provided of the present invention, the height of the packing gland can be directly adjusted from a side surface, thereby adjusting the height of the packings. Fourthly, the materials used by the present invention include either bar materials or forging pieces. Compared with the prior art ball valve which is made by mechanical machining of casting material, the ball valve manufactured in the present invention has a better mechanical performance, a denser material property, and less prone to internal defects.

### DESCRIPTION OF DRAWINGS

The advantages and spirits of the present invention may be further understood with reference to the following detailed description and the accompanying drawings.

FIG. 1 is a schematic structural view of a trunnion ball valve provided according to the present invention;

FIG. 2 is a cross-sectional view of a trunnion ball valve provided according to the present invention;

FIG. 3 is a schematic view of an opening status and a closing status of a trunnion ball valve provided according to the present invention; and

FIG. 4 is a schematic structural view of a bracket provided according to the present invention.

### DETAILED DESCRIPTION OF THE INVENTION

A bracket used for a trunnion ball valve and a trunnion ball valve in a specific embodiment of the present invention are described below in great detail with reference to accompanying drawings. It shall be understood that the present invention is not restricted by the following detailed descriptions, and the technical concepts of the present invention can be implemented by combining with other commonly known techniques or functions or with other techniques the same as those commonly known techniques.

In the following descriptions, in order to clearly show the structure and embodiments of the present invention, many directional terms are introduced to the descriptions. The terms such as “front”, “back”, “left”, “right”, “outer”, “inner”, “external”, “internal”, “axial”, “radial”, etc. shall be considered as being convenient for descriptions, instead of being considered as restriction terms.

An objective of the present invention is to provide a bracket used for a trunnion ball valve and a trunnion ball valve, which not only can extend a service life of a packing by means of tightly pressing the movable packing gland, but also can reduce the manufacturing cost compared with the prior art.

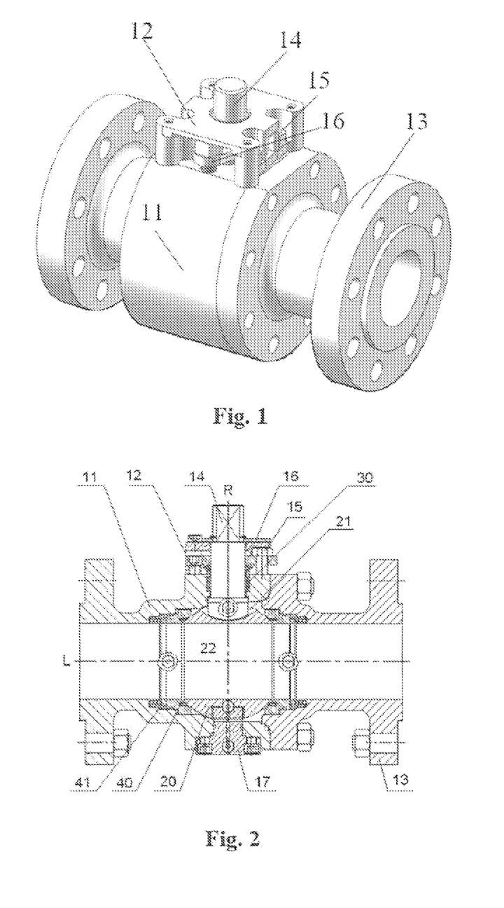

FIG. 1 is a schematic structural view of the trunnion ball valve of the present invention, and FIG. 2 is a cross-sectional view of the trunnion ball valve of the present invention. As shown in FIGS. 1 and 2, the trunnion ball valve of the present invention includes a valve body 11 and a connecting body 13. The valve body 11 includes a body cavity and a passageway. A valve ball 20 is provided within the body cavity. The ball valve can rotate around a rotating axis R, with respect to the valve body 11. The rotating axis R is perpendicular to a longitudinal axis L. The ball 20 includes a through hole 22. A diameter of the through hole 22 of the ball 20 is substantially the same as that of a passageway of the valve body. The ball 20 can rotate around the rotating axis R and shift between two positions, in which a first position is an opening position wherein the through hole 22 and the passageway of the valve ball are aligned with each other, and a second position is a closing position wherein the through hole 22 is in a transversal direction with respect to the passage of the valve ball.

The present invention provides the bracket used for the ball valve, as shown in FIG. 4. The bracket 12 is fixed above the valve body 11, and is configured into a substantial rectangular shape as a whole piece. The bracket 12 includes a plurality of supporting legs 24. Each of the supporting legs 24 has a stopper plate 23 there above. The stopper plate 23 has a through hole used for passing through a valve stem 14. Two opposite sides of the stopper plate 23 are recessed downwards to form bosses, which are used for mounting bolts 15. According to one embodiment of the present invention, four bosses are provided, wherein two of them are configured at a left side, and the other two are configured at a right side symmetrically to those at the left side. However, ordinarily skilled in the art can understand that the bosses can be designed in an asymmetric way, and a plurality of the bosses can be two, three, and so on. Each of the supporting legs 24 is provided with a plurality of threaded holes, which are convenient for installing an auto-control device. The bracket provided in the present invention is not only applicable to the trunnion ball valve, but also applicable to a floating ball valve.

A packing gland 16 is located between the valve body 11 and the bracket 12, and is fixed with the valve body 11 by using the bolts, so that the height of the packing gland 16 can be adjusted by adjusting the height of the bolts. As shown in FIG. 1, the bolts for fixing the packing gland 16 are located in a space formed by the stopper plate, the supporting legs 24, and the valve body 11, the tightness degree of the packing gland can be adjusted at a side surface by using a tool, without opening and disassembling the bracket.

The packing of the present invention is the graphite packing. Compared with the rubber packing material, the graphite packing has advantages of being high temperature resistant and erosion resistant. When the graphite packing is abraded during usage, the height of the packing gland 16 above can be adjusted to enhance the sealing performance, thereby reducing the frequency for replacements.

In one embodiment of the present invention, two valve seats 40 are connected with both sides of the valve body 11 by two clamping rings 41 respectively. The two valve seats 40, the two clamping rings 41, and the valve body 11 are all made of a rigid material, such as stainless steel. In yet another provided on a surface of the valve seat 40 facing the ball 20, which is used for placing a sealing element made of a plastic material. Therefore, when the ball 20 contacts the valve seats 40, because of the plastic sealing element, mediums cannot leak out between the ball and the valve seats. Moreover, since the plastic sealing element is not easily deformed under the pressure, the plastic material on the surface of the valve seats will not be severely damaged when the ball 20 is closely attached and pressed against the valve seats 40 under pressure.

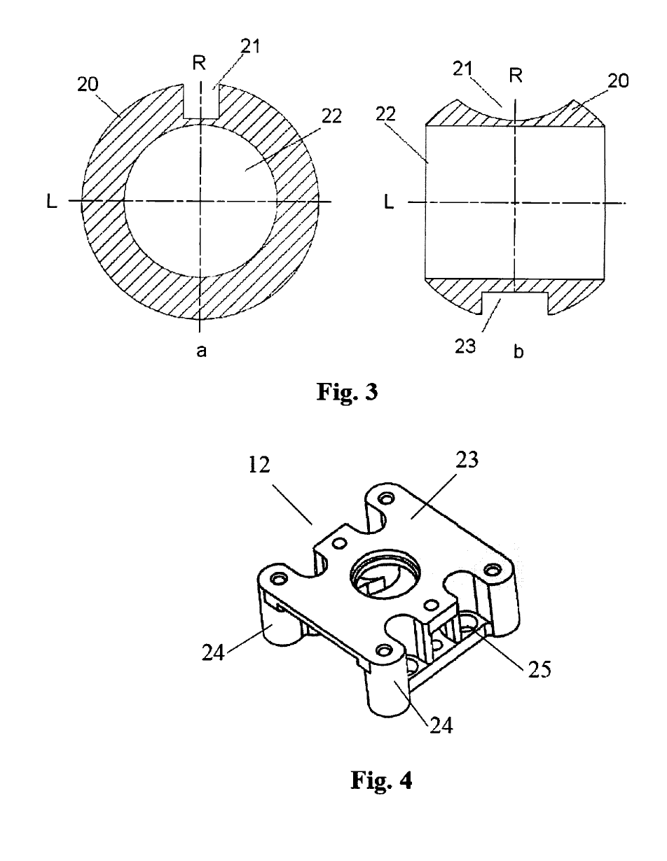

A detailed structural view of the ball 20 provided according to the present invention is shown in FIG. 3. FIG. 3a is a schematic view of the closing position where the through hole 22 is in the transversal direction with respect to the passageway, FIG. 3b is a schematic view of the opening position where the through hole 22 and the passageway are aligned with each other while the ball 20 rotates around the rotating axis R. The ball 20 includes two fixing slots, that is, an upper fixing slot 21 and a lower fixing slot 23. The upper fixing slot 21 is used for accommodating the valve stem 14, and the lower fixing slot 23 is used for accommodating a fixing shaft. A slot bottom of the upper fixing slot 23 is configured into a circular arc shape, and a lower end of the valve stem 14 is shaped to match with the upper fixing slot 23. When the through hole 22 of the ball 20 is in a transversal direction with respect to the passageway, the valve stem 14 and the fixing shaft 17 are both used for securing the ball 20 at the same time, so that the ball 20 does not move.

The valve body and the connecting body of the present invention are manufactured by using either bar materials or forging pieces, which have a better mechanical performance and a denser product property, compared with parts made by casting.

The above detail descriptions in the present invention mainly describe the preferred embodiments of the present invention, which are merely used for describing the technical solutions of the present invention, instead of restricting the present invention. All the technical solutions that can be derived by those skilled in the art by logical analysis, derivation, or limited experiments based on the ideas of the present invention shall fall within the scope of the present invention.

We claim:

1. A bracket used for a ball valve, comprising: a supporting body piece and a stopper plate located above said supporting body piece, wherein a lower surface of said supporting body piece contacts an upper surface of a valve body of the ball valve, and accommodating space is formed between the supporting body piece and the stopper plate.

2. The bracket used for the ball valve of claim 1, wherein the bracket further comprises one supporting body piece which preferably has four supporting legs, wherein each of the supporting legs has a connecting slot thereon, and the stopper plate comprises at least one recessed boss accommodating at least one bolt which fix the bracket to the valve body.

3. A trunnion ball valve, comprising: a valve body, a valve ball, two valve seats, and a valve stem, wherein the valve body comprises a valve body cavity and a packing cavity; the valve ball and the valve seats are located within the valve body cavity; the valve stem connecting with the valve ball is located within the packing cavity; and, graphite packings are filled between the packing cavity and the valve stem, which are pressed by using a packing gland.

4. The trunnion ball valve of claim 3, wherein a height of the packing gland is adjustable.

5. The trunnion ball valve of claim 4, further comprising: a bracket located above the valve body, wherein the packing gland is located within a space formed by the valve body and the bracket.

6. The trunnion ball valve of claim 5, wherein the bracket comprises at least two supporting legs and a stopper plate located above the supporting legs, a lower surface of each of the supporting legs contacts an upper surface of the valve body, and the stopper plate comprises a through hole therein passing through the valve stem.

7. The trunnion ball valve of claim 3, wherein the valve body is manufactured by using either bar materials or forging pieces.

8. The trunnion ball valve of claim 3, wherein the two valve seats are connected with the valve body both ends by two elastic elements respectively, and the valve seats are made of metal or ceramic.

9. The trunnion ball valve of claim 3, wherein the valve stem is located within an upper fixing slot of the valve ball, a slot bottom of the upper fixing slot is formed into a circular arc shape, and a shape of the valve stem is matched with that of the upper fixing slot.

10. The trunnion ball valve of claim 3, wherein the packing gland is fixed with the valve body by two bolts, and a height of the packing gland is adjusted by adjusting a height of the bolts.
